(19) United States
(12) Patent Application Publication
(10) Pub. No.: US 2025/0216670 A1
(43) Pub. Date: Jul. 3, 2025

(54) OPTICAL WAVEGUIDE DEVICE AND NEAR-EYE DISPLAY DEVICE

(71) Applicant: LINGXI-AR Technology Co., Ltd., Beijing (CN)

(72) Inventors: Zhiyuan GU, Beijing (CN); Yu ZHENG, Beijing (CN)

(21) Appl. No.: 19/004,411

(22) Filed: Dec. 29, 2024

(30) Foreign Application Priority Data
Dec. 30, 2023 (CN) 202311866265.5

(51) Int. Cl. G02B 27/00; G02B 27/01; G02B 27/28

(52) U.S. Cl. CPC G02B 27/0081; G02B 27/0172; G02B 27/285; G02B 2027/013

(57) ABSTRACT

Provided are an optical waveguide device and a near-eye display device. The optical waveguide device includes a waveguide element and a pupil-expanding coupling element. The waveguide element includes at least a waveguide substrate and a longitudinal pupil-expanding beam-splitting surface array, where the longitudinal pupil-expanding beam-splitting surface array of the waveguide element is disposed at an angle of 32°≤α<40°. The pupil-expanding coupling element is disposed at an end of the waveguide substrate and includes a triangular prism, a free-surface oblique quadrangular prism and a free-surface triangular prism. A first P-light-transmissive and S-light reflective film or a first semi-transmissve and semi-reflective film is disposed on a triangular prism reflective surface. A total reflection film is disposed on an oblique quadrangular prism reflective surface. A second P-light-transmissive and S-light-reflective film or a second semi-transmissive and semi-reflective film is disposed on a triangular prism plane.

### CROSS-REFERENCE TO RELATED APPLICATION

The present application claims priority to Chinese Patent Application No. 202311866265.5, filed with the China National Intellectual Property Administration (CNIPA) on Dec. 30, 2023, the disclosure of which is incorporated herein by reference in its entirety.

### TECHNICAL FIELD

The present disclosure relates to the field of optical technology and, in particular, to an optical waveguide device and a near-eye display device.

### BACKGROUND

Near-eye display technology is used in head-mounted displays for augmented reality (AR) so that people can view the virtual images being projected while checking the surrounding environment. The virtual images are superimposed on the real world perceived by the user so that a more realistic experience can be created and the user is more immersive.

In recent years, AR technology has developed rapidly, and a series of related commercial products have been released one after another, such as Google Glass, Epson BT-40, Microsoft Hololens2, vivo and Xiaomi AR glasses. Through this technology, virtual images are superimposed on the real world perceived by users to create a realistic experience. Therefore, this technology has broad application prospects in aspects such as military, security, industry and medicine. To implement the function of AR, researchers have provided multiple solutions such as Birdbath, a prism, a free-form surface, an optical waveguide and other technologies. Among the first three solutions, conflicts generally exist between good product forms and relatively excellent display effects, and optical waveguides can effectively solve the above problems.

However, in optical waveguide technology, especially in geometric array optical waveguides, since discrete, partially reflective and partially transmissive beam-splitting surfaces are used for coupling the totally reflected light in the waveguide out to the waveguide, the problem of non-uniform brightness generally occurs at a place where different beam-splitting surfaces are spliced, that is, at a position where exit pupils are spliced. As shown in FIG. 1, since the tilt angle α of the beam-splitting surface of the outcoupling structure is generally within the range of 23° to 26°, the angle of the totally reflected light in the waveguide is mostly within the range of 40° to 60°. According to the geometric relationship, at the position of the outcoupling structure, the same light inevitably passes through the same reflective surface twice. This phenomenon is the essential cause of the non-uniform brightness of the traditional geometric array optical waveguide. Moreover, in this case, the light is incident from the back surface of the reflective surface in the outcoupling structure, thereby generating reflected light that is also the essential cause of ghosting in the geometric array optical waveguide.

To solve the above problems, researchers generally optimize multiple films or attach a substrate with a certain thickness to the outer sides of the two parallel planes that limit total reflection transmission in the geometric array waveguide. However, both the two methods can only alleviate the problem of non-uniform brightness and have relatively high manufacturing costs.

### SUMMARY

According to the problems existing in the related art, the present disclosure provides an optical waveguide device and a near-eye display device.

The technical solutions of the present disclosure are described below.

The technical solutions used in the present disclosure achieve the beneficial effects described below.

An optical waveguide device includes a waveguide element and a pupil-expanding coupling element.

The waveguide element includes at least a waveguide substrate and a longitudinal pupil-expanding beam-splitting surface array located inside the waveguide substrate, where the longitudinal pupil-expanding beam-splitting surface array includes multiple stacked first beam-splitting slopes, each of the multiple first beam-splitting slopes forms an angle α along a stacking direction, 32°≤the angle α<40°, and a spacing between the multiple first beam-splitting slopes is 1/tan α times a thickness of the waveguide substrate.

The pupil-expanding coupling element is disposed at an end of the waveguide substrate and includes a triangular prism, a free-surface oblique quadrangular prism and a free-surface triangular prism.

A side surface of the triangular prism includes a triangular prism incident surface and a triangular prism reflective surface, and a first P-light-transmissive and S-light-reflective film or a first semi-transmissive and semi-reflective film is disposed on the triangular prism reflective surface; a side surface of the free-surface oblique quadrangular prism includes a first oblique quadrangular prism incident surface and an oblique quadrangular prism reflective surface that are parallel to each other and a second oblique quadrangular prism incident surface and an oblique quadrangular prism bottom surface that are parallel to each other, the first oblique quadrangular prism incident surface is connected to the triangular prism reflective surface, and a total reflection film is disposed on the oblique quadrangular prism reflective surface; a side surface of the free-surface triangular prism includes a triangular prism incident plane, a triangular prism plane and a triangular prism free surface, a second P-light-transmissive and S-light-reflective film or a second semi-transmissive and semi-reflective film is disposed on the triangular prism plane, and the triangular prism plane is connected to a side of the waveguide substrate.

An included angle β is formed between a projection of the triangular prism incident surface and a projection of the triangular prism reflective surface, and the included angle β=α.

An acute included angle γ is formed between a projection surface of the triangular prism plane and a projection surface of the triangular prism free surface so that light is subjected to pupil expansion by the pupil-expanding coupling element into two beams of light that are coupled into the waveguide element and both the two beams of light are transmitted through total reflection in the waveguide substrate and perform penetration once when passing through each of the multiple beam-splitting slopes.

As a preferred technical solution, the total reflection has an angle of 60° to 80°, and the included angle γ≤15°.

As a preferred technical solution, the waveguide substrate has a thickness of 1.1-1.8 mm.

As a preferred technical solution, the triangular prism is a right-angled triangular prism, a side surface of the right-angled triangular prism further includes a triangular prism transmissive surface perpendicular to the triangular prism reflective surface, and the triangular prism transmissive surface is connected to an end surface of the waveguide substrate.

As a preferred technical solution, the triangular prism free surface is a triangular prism free plane or a triangular prism free convex surface, and the oblique quadrangular prism bottom surface is an oblique quadrangular prism plane or an oblique quadrangular prism convex surface.

As a preferred technical solution, both the first P-light-transmissive and S-light-reflective film and the second P-light-transmissive and S-light-reflective film are Polarizing Beam Splitter (PBS) films.

As a preferred technical solution, the triangular prism incident plane is perpendicular to the triangular prism plane, and a length of the second P-light-transmissive and S-light-reflective film or a length of the second semi-transmissive and semi-reflective film is 1/tan γ times a length of the waveguide substrate.

As a preferred technical solution, the angle α=35°, and the waveguide element includes an entrance pupil region having a sectional diameter of 2.56 mm at the waveguide substrate.

As a preferred technical solution, the optical waveguide device further includes a transverse pupil-expanding beam-splitting surface array, where the transverse pupil-expanding beam-splitting surface array includes multiple stacked second beam-splitting slopes, an angle θ is formed between each of the multiple second beam-splitting slopes and the stacking direction of the multiple first beam-splitting slopes, and 0°≤the angle θ<90°.

The present application further provides a near-eye display device. The near-eye display device includes the above optical waveguide device.

In the optical waveguide device and the near-eye display device that are provided in the present disclosure, the tilt angle of the beam-splitting surface of the array waveguide is appropriately increased, and the pupil-expanding coupling element is disposed so that the incident light is incident on the pupil-expanding coupling element; the P-light-transmissive and S-light-reflective film or the first semi-transmissive and semi-reflective film is disposed in the structure of the pupil-expanding coupling element to complete pupil expansion for two beams of light, and the two beams of light are coupled into the longitudinal pupil-expanding beam-splitting surface array in the waveguide element, are both transmitted through total reflection and both perform penetration only once when passing through each beam-splitting slope, thereby extremely and effectively improving the brightness uniformity of the waveguide within a range of 60° to 80° of the total reflection light angle. This structure effectively and fundamentally solves the problems of brightness uniformity and ghosting.

### BRIEF DESCRIPTION OF DRAWINGS

To describe the technical solutions of the embodiments in the present disclosure more clearly, the drawings that need to be used in the description of the embodiments will be briefly described below and form a part of the present disclosure. The example embodiments and descriptions thereof in the present disclosure explain the present disclosure and do not limit the present disclosure in any improper way.

FIG. 1 is a schematic diagram of an optical path of a waveguide structure in the related art.

FIG. 2 is a structure diagram of an optical waveguide device according to the present embodiment one.

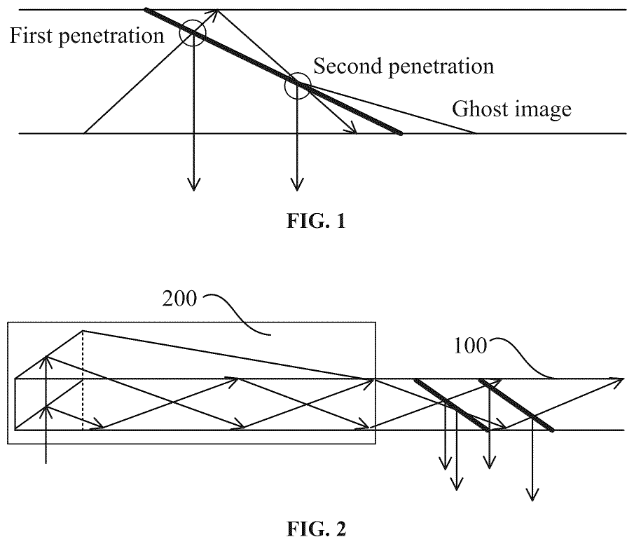

### REFERENCE LIST

100 waveguide element
200 pupil-expanding coupling element

### DETAILED DESCRIPTION

To illustrate the objects, technical solutions and advantages of the present disclosure more clearly, the technical solutions the present disclosure will be described clearly and completely in conjunction with the embodiments and corresponding drawings of the present disclosure. In the description of the present disclosure, it is to be noted that the term “or” is generally used in a meaning including “and/or” unless the content clearly indicates otherwise.

In the description of the present disclosure, it is to be understood that terms “first”, “second” and the like are used only for the purpose of description and are not to be construed as indicating or implying relative importance. In the description of the present disclosure, it is to be noted that unless otherwise expressly specified and limited, the term “connected to each other”, or “connected” should be construed in a broad sense, for example, as securely connected, detachably connected, or integrally connected; mechanically connected or electrically connected; directly connected to each other or indirectly connected to each other via an intermediary. For those of ordinary skill in the art, specific meanings of the preceding terms in the present disclosure may be understood based on specific situations.

In addition, those skilled in the art should be understood that in the description of the present disclosure, orientational or positional relationships indicated by terms “longitudinal”, “transverse”, “above”, “below”, “front”, “back”, “left”, “right”, “vertical”, “horizontal”, “top”, “bottom”, “inside”, “outside” and the like are based on the orientational or positional relationships illustrated in the drawings, which are merely for facilitating and simplifying the description of the present disclosure. These relationships do not indicate or imply that an apparatus or component referred to have a specific orientation and is constructed and operated in a specific orientation, and thus it is not to be construed as limiting the present disclosure.

Apparently, the described embodiments are part, not all, of embodiments of the present disclosure. Based on the embodiments of the present disclosure, all other embodiments obtained by those of ordinary skill in the art without creative work are within the scope of the present disclosure.

### Embodiment One

According to FIG. 2, the present embodiment provides an optical waveguide device. The optical waveguide device includes a waveguide element and a pupil-expanding coupling element 200.

The waveguide element includes at least a waveguide substrate and a longitudinal pupil-expanding beam-splitting surface array located inside the waveguide substrate, where the longitudinal pupil-expanding beam-splitting surface array includes multiple stacked first beam-splitting slopes, each of the multiple first beam-splitting slopes forms an angle α along a stacking direction, 32°≤the angle α<40°, and a spacing between the multiple first beam-splitting slopes is 1/tan α times a thickness of the waveguide substrate.

The pupil-expanding coupling element 200 is disposed at an end of the waveguide substrate and includes a triangular prism, a free-surface oblique quadrangular prism and a free-surface triangular prism.

A side surface of the triangular prism includes a triangular prism incident surface and a triangular prism reflective surface, and a first P-light-transmissive and S-light-reflective film or a first semi-transmissive and semi-reflective film is disposed on the triangular prism reflective surface; a side surface of the free-surface oblique quadrangular prism includes a first oblique quadrangular prism incident surface and an oblique quadrangular prism reflective surface that are parallel to each other and a second oblique quadrangular prism incident surface and an oblique quadrangular prism bottom surface that are parallel to each other, the first oblique quadrangular prism incident surface is connected to the triangular prism reflective surface, and a total reflection film is disposed on the oblique quadrangular prism reflective surface; a side surface of the free-surface triangular prism includes a triangular prism incident plane, a triangular prism plane and a triangular prism free surface, a second P-light-transmissive and S-light-reflective film or a second semi-transmissive and semi-reflective film is disposed on the triangular prism plane, and the triangular prism plane is connected to a side of the waveguide substrate.

An included angle β is formed between a projection of the triangular prism incident surface and a projection of the triangular prism reflective surface, and the included angle β=α.

An acute included angle γ is formed between a projection surface of the triangular prism plane and a projection surface of the triangular prism free surface so that light is subjected to pupil expansion by the pupil-expanding coupling element 200 into two beams of light that are coupled into the waveguide element 100 and both the two beams of light are transmitted through total reflection in the waveguide substrate and perform penetration once when passing through each of the multiple beam-splitting slopes.

Based on the problems of non-uniform brightness and ghosting in existing waveguide devices, the present embodiment provides the optical waveguide device. The tilt angle of the beam-splitting surface of the array waveguide is appropriately increased, and the pupil-expanding coupling element 200 is disposed so that the incident light is incident on the pupil-expanding coupling element 200; the P-light-transmissive and S-light-reflective film or the first semi-transmissive and semi-reflective film is disposed in the structure of the pupil-expanding coupling element 200 to complete pupil expansion for two beams of light, and the two beams of light are coupled into the longitudinal pupil-expanding beam-splitting surface array in the waveguide element 100, are both transmitted through total reflection and both perform penetration only once when passing through each beam-splitting slope, thereby extremely and effectively improving the brightness uniformity of the waveguide within a range of 60° to 80° of the total reflection light angle. This structure effectively and fundamentally solves the problems of brightness uniformity and ghosting, has high light emission efficiency and does not increase the volume burden of the waveguide element 100.

Preferably, the total reflection has an angle of 60° to 80°, and the included angle γ≤15°.

Preferably, the waveguide substrate has a thickness of 1.1-1.8 mm.

Specifically, in the present embodiment, the angle (the angle α) of the beam-splitting surface of the longitudinal pupil-expanding beam-splitting surface array is increased, and 32°≤α <40°, preferably 32°≤α<37°. Moreover, under this condition and within a range of 60° to 80° of the total reflection angle, the brightness uniformity of the waveguide is extremely and effectively improved in this manner.

The waveguide substrate includes an upper substrate and a lower substrate, and the longitudinal pupil-expanding beam-splitting surface array is disposed between the upper substrate and the lower substrate. The material of the waveguide substrate and the pupil-expanding coupling element 200 may be a transparent glass material or a transparent resin material and is not specifically limited here.

Preferably, the triangular prism is a right-angled triangular prism, a side surface of the right-angled triangular prism further includes a triangular prism transmissive surface perpendicular to the triangular prism reflective surface, and the triangular prism transmissive surface is connected to an end surface of the waveguide substrate.

Preferably, the triangular prism free surface is a triangular prism free plane or a triangular prism free convex surface, and the oblique quadrangular prism bottom surface is an oblique quadrangular prism plane or an oblique quadrangular prism convex surface.

Specifically, the pupil-expanding coupling element 200 is an integrated prism structure divided into three portions, that is, the triangular prism, the free-surface oblique quadrangular prism and the free-surface triangular prism. The triangular prism is preferably a first right-angled triangular prism, a side surface of the first right-angled triangular prism includes a triangular prism incident surface, a triangular prism reflective surface and a triangular prism transmissive surface, the triangular prism incident surface, the triangular prism reflective surface and the triangular prism transmissive surface are all rectangular, the triangular prism transmissive surface is disposed at an end of the waveguide substrate, and the triangular prism reflective surface is connected to the free-surface oblique quadrangular prism. The free-surface oblique quadrangular prism is preferably an oblique quadrangular prism, a side surface of the oblique quadrangular prism includes a first oblique quadrangular prism incident surface and an oblique quadrangular prism reflective surface that are parallel to each other and a second oblique quadrangular prism incident surface and an oblique quadrangular prism bottom surface that are parallel to each other, and the first oblique quadrangular prism incident surface is connected to the triangular prism reflective surface. The free-surface triangular prism is preferably a second right-angled triangular prism, a side surface of the second right-angled triangular prism includes a triangular prism incident plane, a triangular prism plane and a triangular prism free surface, the triangular prism incident plane is connected to the second oblique quadrangular prism incident surface, and the triangular prism plane is connected to an upper surface of the waveguide element 100, that is, a surface of the waveguide substrate. In addition, both the triangular prism free surface of the free-surface triangular prism and the oblique quadrangular prism bottom surface of the free-surface oblique quadrangular prism may be planes or convex surfaces according to actual needs. Alternatively, the triangular prism free surface is a plane, and the oblique quadrangular prism bottom surface of the free-surface oblique quadrangular prism is a convex surface. Alternatively, the oblique quadrangular prism bottom surface of the free-surface oblique quadrangular prism is a plane, and the triangular prism free surface is a convex surface. Preferably, both the triangular prism free surface and the oblique quadrangular prism bottom surface are planes, thereby effectively reducing the volume of the pupil-expanding coupling element 200.

Viewed from a side view, the right-angled triangular prism is projected as a first triangle, the free-surface oblique quadrangular prism is connected and projected as a parallelogram, the free-surface triangular prism is projected as a second triangle, one right-angled side of the first triangle is connected to the waveguide element 100, a hypotenuse of the first triangle is connected to a long side of the parallelogram, the other right-angled side of the first triangle is used as a light incident region, a short side of the parallelogram is connected to the second triangle, and a side of the second triangle is connected to the waveguide element 100. In short, the free-surface oblique quadrangular prism is located between the triangular prism and the free-surface triangular prism. The acute included angle γ is formed between the projection surface of the triangular prism plane and the projection surface of the triangular prism free surface, which is the second triangle. The second triangle includes a first side connected to the element, a second side connected to the parallelogram and a third side. An included angle between the first side and the second side is γ, and γ is an acute angle, preferably 0°<γ≤15°. γ is the key point for the pupil expansion of the pupil-expanding coupling element 200.

The pupil-expanding coupling element 200 is not only used for coupling the image light into the waveguide element 100, but also has the function to perform pupil expansion on the incident light in advance, thereby effectively ensuring that the brightness uniformity is essentially solved without causing the problem of an excessively large exit pupil of the light engine.

The connections mentioned above are all preferably performed in a manner of fixing and connecting together by using a colloid and may also be performed in other fixing manners. Specifically, the connection manners may be flexibly selected according to the needs of use and are not limited here.

Preferably, both the first P-light-transmissive and S-light-reflective film and the second P-light-transmissive and S-light-reflective film are PBS films.

Specifically, on the basis of the above pupil-expanding coupling element 200, the first P-light-transmissive and S-light-reflective film or the first semi-transmissive and semi-reflective film is disposed on the triangular prism reflective surface of the triangular prism, and the total reflection film is disposed on the oblique quadrangular prism reflective surface of the free-surface oblique quadrangular prism, and the second P-light-transmissive and S-light-reflective film or the first semi-transmissive and semi-reflective film is disposed on the triangular prism plane of the free-surface triangular prism. The thickness of the first P-light-transmissive and S-light-reflective film or the first semi-transmissive and semi-reflective film, the thickness of the total reflection film and the thickness of the second P-light-transmissive and S-light-reflective film or the second semi-transmissive and semi-reflective film may all be flexibly selected according to actual situations and are not specifically limited here.

In the present embodiment, preferably, the first P-light-transmissive and S-light-reflective film is disposed on the triangular prism reflective surface of the triangular prism, and the second P-light-transmissive and S-light-reflective film is disposed on the triangular prism plane of the free-surface triangular prism.

In this case, the incident light enters the triangular prism via the triangular prism incident surface. When the incident light is incident on the triangular prism reflective surface, a portion of the light, that is, a first portion of the light, that is, the P light, passes through the triangular prism reflective surface and the first oblique quadrangular prism incident surface before entering the free-surface oblique quadrangular prism due to the existence of the first P-light-transmissive and S-light-reflective film. The other portion of the light, that is, a second portion of the light, namely, the S light does not enter other portions of the pupil-expanding coupling element 200 due to the existence of the first P-light-transmissive and S-light-reflective film, which is equivalent to limiting the S light to propagate only in the waveguide substrate. The S light is reflected, enters the waveguide element 100, propagates in the waveguide substrate at a total reflection angle and performs penetration once when passing through each beam-splitting surface in the internal longitudinal pupil-expanding beam-splitting surface array. When the second portion of the light that enters the free-surface oblique quadrangular prism, that is, the P light, is incident on the oblique quadrangular prism reflective surface, the second portion of the light is totally reflected, passes through the second oblique quadrangular prism incident surface and the triangular prism incident surface and enters the free-surface triangular prism due to the existence of the total reflection film. In this case, the P light continues to be transmitted to the triangular prism plane. The P light passes through the triangular prism plane and enters the waveguide element 100 due to the existence of the second P-light-transmissive and S-light-reflective film or the second semi-transmissive and semi-reflective film. In this case, the P light also propagates in the waveguide substrate at the same total reflection angle and performs penetration once when passing through each beam-splitting surface in the internal longitudinal pupil-expanding beam-splitting surface array. The penetration may be understood as follows: the light performs penetration once when passing through each beam-splitting surface. For example, the light passes through the first beam-splitting surface, is directly incident on the second beam-splitting surface after penetration and is directly incident on the third beam-splitting surface after penetration for penetration once. The rest are done in the same manner.

Preferably, the triangular prism incident plane is perpendicular to the triangular prism plane, and a length of the second P-light-transmissive and S-light-reflective film or a length of the second semi-transmissive and semi-reflective film is 1/tan γ times a length of the waveguide substrate.

Preferably, the angle α=35°, and the waveguide element 100 includes an entrance pupil region having a sectional diameter of 2.56 mm at the waveguide substrate.

Specifically, compared with the traditional manner, the angle α of the beam-splitting surface of the longitudinal pupil-expanding beam-splitting surface array is increased in the present embodiment, and the angle may be any angle within a range of 32° to 37°, preferably 35°. According to the geometric relationship, the total reflection angle of light in the waveguide is within a range of 60° to 80°. In this case, each time the same light passes through a beam-splitting surface, the same light penetrates the beam-splitting surface only once, and there is no problem that the same light penetrates the same reflective surface multiple times. Therefore, the problems of brightness uniformity and ghosting can be fundamentally solved in theory.

In the case of a waveguide substrate with the same thickness, to make light completely fill the entrance pupil of the waveguide, the entrance pupil of the waveguide is 3 mm when the angle range of the total reflection light in the waveguide is 60° to 80°. However, the entrance pupil is 5.64 mm and the entrance pupil dimension is increased by 88% when the angle range of the total reflection light in the waveguide is 60° to 80°. An increase in the entrance pupil dimension of the waveguide means that a light engine with a larger exit pupil dimension is required.

To further solve the problem of an excessively large exit pupil of the light engine, in FIG. 2, the dotted line is an entrance pupil distance of the waveguide, the triangular prism plane is used as a dividing line, and the entire dotted line is divided into an upper portion and a lower portion. The P-light-transmissive and S-light-reflective film or the semi-transmissive and semi-reflective film and the total reflection film are used in the pupil-expanding coupling element 200 for performing pupil expansion once on the incident light in advance. That is, when the incident light enters the pupil-expanding coupling element 200, the light with half of the energy is reflected by the first P-light-transmissive and S-light-reflective film or the first semi-transmissive and semi-reflective film, and the reflected light fills half of the entrance pupil of the waveguide, that is, the lower portion of the dotted line in FIG. 2. When the second P-light-transmissive and S-light-reflective film or the second semi-transmissive and semi-reflective film is encountered, the light continues to be reflected due to the same polarization, thereby limiting the total reflection transmission in the waveguide substrate, rather than the absorption performed by the absorption surface after transmission. If the light is absorbed, the entrance pupil of the waveguide is not filled. The other half of the light passes through the first P-light-transmissive and S-light-reflective film and is reflected by the total reflection film. This portion of the light fills the other half of the entrance pupil of the waveguide, that is, the upper portion of the dotted line in FIG. 2. Then, this portion of the light passes through the second P-light-transmissive and S-light-reflective film or the second semi-transmissive and semi-reflective film and enters the waveguide substrate for total reflection transmission.

In the above process, a structure consisting of the first P-light-transmissive and S-light-reflective film or the first semi-transmissive and semi-reflective film, the second P-light-transmissive and S-light-reflective film or the second semi-transmissive and semi-reflective film and the total reflection film is used for replicating the incident light into two copies, and each of the two copies of incident light fills half of the entrance pupil of the waveguide, enters the waveguide plane 1 and the waveguide plane 2 for transmission, is finally coupled into the waveguide by the coupling structure and enters human eyes.

In the solution provided above, pupil expansion is performed on the incident light in advance, that is, pupil expansion is performed on the exit pupil of the light engine. Therefore, the light engine needs to fill only ½ of the entrance pupil of the waveguide to fill the entire entrance pupil of the waveguide. In the solution of the present embodiment, the exit pupil of the light engine needs to be only 2.56 mm which is reduced by 55% compared with the previous 5.64 mm, thereby significantly reducing the volume of the system. Moreover, when the angle range of the total reflection light is 60° to 80°, the brightness uniformity of the waveguide is also improved.

Preferably, the optical waveguide device further includes a transverse pupil-expanding beam-splitting surface array, where the transverse pupil-expanding beam-splitting surface array includes multiple stacked second beam-splitting slopes, an angle θ is formed between each of the multiple second beam-splitting slopes and the stacking direction of the multiple first beam-splitting slopes, and 0°≤the angle θ<45°.

Specifically, the pupil-expanding coupling element 200 is not only suitable for one-dimensional reflective waveguide plates, but also for two-dimensional array waveguide structures.

The exit pupil of the one-dimensional reflective waveguide plate is expanded in one direction, and generally, the one-dimensional reflective waveguide plate mainly includes a pupil-expanding coupling element 200 and an outcoupling structure. The outcoupling structure of the one-dimensional reflective waveguide plate includes a waveguide substrate and a longitudinal pupil-expanding beam-splitting surface array located inside the waveguide substrate.

The exit pupil of the two-dimensional reflective waveguide plate can be expanded in two directions, and generally, the two-dimensional reflective waveguide plate mainly includes a pupil-expanding coupling element 200, a turning structure and an outcoupling structure. The turning structure includes a waveguide substrate and a longitudinal pupil-expanding beam-splitting surface array located inside the waveguide substrate, and the outcoupling structure includes a waveguide substrate and a transverse pupil-expanding beam-splitting surface array located inside the waveguide substrate.

Furthermore, both the outcoupling structure of the one-dimensional reflective waveguide plate and the turning structure of the two-dimensional reflective waveguide plate include a waveguide substrate and a longitudinal pupil-expanding beam-splitting surface array located inside the waveguide substrate. More specifically, the outcoupling structure of the one-dimensional reflective waveguide plate and the turning structure of the two-dimensional reflective waveguide plate include multiple waveguide plates that are parallel to each other and multiple beam-splitting mirrors that are parallel to each other. The beam-splitting mirror is embedded between two adjacent waveguide plates, and the multiple waveguide plates and the multiple beam-splitting mirrors are alternately disposed. The spacing between the multiple beam-splitting mirrors is 1/tan α times the thickness of the waveguide substrate, and each of the multiple beam-splitting mirrors forms an angle α along the stacking direction, preferably 32°≤the angle α≤37°. The structure of the pupil-expanding coupling element 200 is preferably the first P-light-transmissive and S-light-reflective film, the second P-light-transmissive and S-light-reflective film or the total reflection film. The angle γ in the free-surface triangular prism and the included angle β of the triangular prism are preferably 0°<γ≤15° and β=α. The above cooperate with each other and are indispensable to achieve high quality and essentially improve the brightness uniformity of the waveguide so that no problem of ghosting occurs and the volume of the waveguide element 100 is not increased.

Similarly, the outcoupling structure of the two-dimensional reflective waveguide plate includes multiple waveguide plates that are parallel to each other and multiple beam-splitting mirrors that are parallel to each other. The beam-splitting mirror is embedded between two adjacent waveguide plates, and the multiple second waveguide plates and the multiple second beam-splitting mirrors are alternately disposed. In the transverse pupil-expanding beam-splitting surface array, the waveguide plate is disposed along the arrangement direction of the transverse pupil-expanding beam-splitting surface array at an angle of greater than or equal to 0° and less than 90°. Both of the waveguide plate and the beam-splitting mirror satisfy that the brightness uniformity of the waveguide is essentially improved and the problem of ghosting is effectively solved.

### Embodiment Two

The present embodiment provides a near-eye display device. The near-eye display device includes the optical waveguide device in embodiment one. The problems of brightness uniformity and ghosting are solved effectively and fundamentally and the light emission efficiency is high to ensure that the image information on the display element is completely irradiated and presented to human eyes.

The above describes the optical waveguide device and the near-eye display device in the embodiments of the present application in detail. The principles and implementations of the present application are described herein with specific examples. The above description of the embodiments is merely for assisting in understanding the method of the present application and its core ideas. At the same time, for those of ordinary skill in the art, according to the idea of the present application, there will be changes in specific implementations and applications. In summary, the content of this specification should not be construed as limiting the application.

What is claimed is:

1. An optical waveguide device, comprising:
a waveguide element comprising at least a waveguide substrate and a longitudinal pupil-expanding beam-splitting surface array located inside the waveguide substrate, wherein the longitudinal pupil-expanding beam-splitting surface array comprises a plurality of stacked first beam-splitting slopes, each of the plurality of first beam-splitting slopes forms an angle α along a stacking direction, 32°≤the angle α<40°, and a spacing between the plurality of first beam-splitting slopes is 1/tan α times a thickness of the waveguide substrate; and
a pupil-expanding coupling element disposed at an end of the waveguide substrate and comprising a triangular prism, a free-surface oblique quadrangular prism and a free-surface triangular prism;
wherein a side surface of the triangular prism comprises a triangular prism incident surface and a triangular prism reflective surface, and a first P-light-transmissive and S-light-reflective film or a first semi-transmissive and semi-reflective film is disposed on the triangular prism reflective surface; a side surface of the free-surface oblique quadrangular prism comprises a first oblique quadrangular prism incident surface and an oblique quadrangular prism reflective surface that are parallel to each other and a second oblique quadrangular prism incident surface and an oblique quadrangular prism bottom surface that are parallel to each other, the first oblique quadrangular prism incident surface is connected to the triangular prism reflective surface, and a total reflection film is disposed on the oblique quadrangular prism reflective surface; a side surface of the free-surface triangular prism comprises a triangular prism incident plane, a triangular prism plane and a triangular prism free surface, a second P-light-transmissive and S-light-reflective film or a second semi-transmissive and semi-reflective film is disposed on the triangular prism plane, and the triangular prism plane is connected to a side of the waveguide substrate; and
an included angle β is formed between a projection of the triangular prism incident surface and a projection of the triangular prism reflective surface, and the included angle β=α; an acute included angle γ is formed between a projection surface of the triangular prism plane and a projection surface of the triangular prism free surface, γ is an angle of a second triangle; the second triangle comprises a first side connected to the waveguide element, a second side connected to a parallelogram and a third side, an included angle between the first side and the second side is γ, and 0°<γ≤15° so that light is subjected to pupil expansion by the pupil-expanding coupling element into two beams of light that are coupled into the waveguide element and both the two beams of light are transmitted through total reflection in the waveguide substrate and perform penetration once when passing through each of the plurality of beam-splitting slopes.

2. The optical waveguide device according to claim 1, wherein the total reflection has an angle of 60° to 80°.

3. The optical waveguide device according to claim 1, wherein the waveguide substrate has a thickness of 1.1-1.8 mm.

4. The optical waveguide device according to claim 1, wherein the triangular prism is a right-angled triangular prism, a side surface of the right-angled triangular prism further comprises a triangular prism transmissive surface perpendicular to the triangular prism reflective surface, and the triangular prism transmissive surface is connected to an end surface of the waveguide substrate.

5. The optical waveguide device according to claim 1, wherein the triangular prism free surface is a triangular prism free plane or a triangular prism free convex surface, and the oblique quadrangular prism bottom surface is an oblique quadrangular prism plane or an oblique quadrangular prism convex surface.

6. The optical waveguide device according to claim 1, wherein both the first P-light-transmissive and S-light-reflective film and the second P-light-transmissive and S-light-reflective film are Polarizing Beam Splitter (PBS) films.

7. The optical waveguide device according to claim 1, wherein the triangular prism incident plane is perpendicular to the triangular prism plane, and a length of the second P-light-transmissive and S-light-reflective film or a length of the second semi-transmissive and semi-reflective film is 1/tan γ times a length of the waveguide substrate.

8. The optical waveguide device according to claim 2, wherein the angle α=35°, and the waveguide element comprises an entrance pupil region having a sectional diameter of 2.56 mm at the waveguide substrate.

9. The optical waveguide device according to claim 1, further comprising a transverse pupil-expanding beam-splitting surface array, wherein the transverse pupil-expanding beam-splitting surface array comprises a plurality of stacked second beam-splitting slopes, an angle θ is formed between each of the plurality of second beam-splitting slopes and the stacking direction of the plurality of first beam-splitting slopes, and 0°≤the angle θ<90°.

10. A near-eye display device, comprising an optical waveguide device,
wherein the optical waveguide device comprises:
a waveguide element comprising at least a waveguide substrate and a longitudinal pupil-expanding beam-splitting surface array located inside the waveguide substrate, wherein the longitudinal pupil-expanding beam-splitting surface array comprises a plurality of stacked first beam-splitting slopes, each of the plurality of first beam-splitting slopes forms an angle α along a stacking direction, 32°≤the angle α<40°, and a spacing between the plurality of first beam-splitting slopes is 1/tan α times a thickness of the waveguide substrate; and
a pupil-expanding coupling element disposed at an end of the waveguide substrate and comprising a triangular prism, a free-surface oblique quadrangular prism and a free-surface triangular prism;
wherein a side surface of the triangular prism comprises a triangular prism incident surface and a triangular prism reflective surface, and a first P-light-transmissive and S-light-reflective film or a first semi-transmissive and semi-reflective film is disposed on the triangular prism reflective surface; a side surface of the free-surface oblique quadrangular prism comprises a first oblique quadrangular prism incident surface and an oblique quadrangular prism reflective surface that are parallel to each other and a second oblique quadrangular prism incident surface and an oblique quadrangular prism bottom surface that are parallel to each other, the first oblique quadrangular prism incident surface is connected to the triangular prism reflective surface, and a total reflection film is disposed on the oblique quadrangular prism reflective surface; a side surface of the free-surface triangular prism comprises a triangular prism incident plane, a triangular prism plane and a triangular prism free surface, a second P-light-transmissive and S-light-reflective film or a second semi-transmissive and semi-reflective film is disposed on the triangular prism plane, and the triangular prism plane is connected to a side of the waveguide substrate; and
an included angle β is formed between a projection of the triangular prism incident surface and a projection of the triangular prism reflective surface, and the included angle β=α; an acute included angle γ is formed between a projection surface of the triangular prism plane and a projection surface of the triangular prism free surface, γ is an angle of a second triangle; the second triangle comprises a first side connected to the waveguide element, a second side connected to a parallelogram and a third side, an included angle between the first side and the second side is γ, and 0°<γ≤15° so that light is subjected to pupil expansion by the pupil-expanding coupling element into two beams of light that are coupled into the waveguide element and both the two beams of light are transmitted through total reflection in the waveguide substrate and perform penetration once when passing through each of the plurality of beam-splitting slopes.

11. The near-eye display device according to claim 10, wherein the total reflection has an angle of 60° to 80°.

12. The near-eye display device according to claim 10, wherein the waveguide substrate has a thickness of 1.1-1.8 mm.

13. The near-eye display device according to claim 10, wherein the triangular prism is a right-angled triangular prism, a side surface of the right-angled triangular prism further comprises a triangular prism transmissive surface perpendicular to the triangular prism reflective surface, and the triangular prism transmissive surface is connected to an end surface of the waveguide substrate.

14. The near-eye display device according to claim 10, wherein the triangular prism free surface is a triangular prism free plane or a triangular prism free convex surface, and the oblique quadrangular prism bottom surface is an oblique quadrangular prism plane or an oblique quadrangular prism convex surface.

15. The near-eye display device according to claim 10, wherein both the first P-light-transmissive and S-light-reflective film and the second P-light-transmissive and S-light-reflective film are Polarizing Beam Splitter (PBS) films.

16. The near-eye display device according to claim 10, wherein the triangular prism incident plane is perpendicular to the triangular prism plane, and a length of the second P-light-transmissive and S-light-reflective film or a length of the second semi-transmissive and semi-reflective film is 1/tan γ times a length of the waveguide substrate.

17. The near-eye display device according to claim 11, wherein the angle α=35°, and the waveguide element comprises an entrance pupil region having a sectional diameter of 2.56 mm at the waveguide substrate.

18. The near-eye display device according to claim 10, wherein the optical waveguide device further comprises a transverse pupil-expanding beam-splitting surface array, wherein the transverse pupil-expanding beam-splitting surface array comprises a plurality of stacked second beam-splitting slopes, an angle θ is formed between each of the plurality of second beam-splitting slopes and the stacking direction of the plurality of first beam-splitting slopes, and 0°≤the angle θ<90°.
